(19) United States
(12) Patent Application Publication
(10) Pub. No.: US 2012/0280635 A1
(43) Pub. Date: Nov. 8, 2012

(54) AC LIGHT-EMITTING DEVICE

(75) Inventors: YU-KANG LU, TAIPEI (TW); WEN-HSIANG LIN, TAIPEI (TW); SHIH-CHIANG YEN, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/436,058

(22) Filed: Mar. 30, 2012

(30) Foreign Application Priority Data
May 5, 2011 (CN) 201110122670.7

(51) Int. Cl. H05B 37/00

(52) U.S. Cl. 315/250

(57) ABSTRACT

An alternating current (AC) light-emitting device includes a waveform generating unit and an AC light-emitting unit. The waveform generating unit is configured to receive an AC electrical signal and to generate a drive signal by adjusting one of: voltage amplitude of the AC electrical signal during one of positive and negative half-cycles of the AC electrical signal, and waveform level of the AC electrical signal. The AC light-emitting unit includes a first light-emitting component and a second light-emitting component, and the second light-emitting component emits a different wavelength light compared to that emitted by the first light-emitting component. The first and second light-emitting components are electrically coupled to the waveform generating unit to receive the drive signal, and emit light according to the drive signal.

### CROSS-REFERENCE TO RELATED APPLICATION

This application claims priority to Chinese Application No. 201110122670.7, filed on May 5, 2011.

### BACKGROUND OF THE INVENTION

1. Field of the Invention

The invention relates to an alternating current (AC) light-emitting device, and more particularly to an AC light-emitting device that permits adjustment of color temperature.

2. Description of the Related Art

As the technology of alternating current light-emitting diodes (AC LED) becomes more and more mature, applications thereof have also increased. Therefore, for a light-emitting device incorporating AC LEDs as the light source, several techniques have been proposed to efficiently adjust color temperature.

FIG. 1 and FIG. 2 show another conventional AC light-emitting device 3 disclosed in Taiwanese Patent Publication No. 200723956. The AC light-emitting device 3 includes a voltage phase controller 31, a multi-phase voltage generator 32 and three AC light-emitting diode modules 33-35. The voltage phase controller 31 generates a voltage phase control signal according to the operation of an external setup device 42. The multi-phase voltage generator 32 receives a sinusoidal single phase voltage from an external single phase voltage source 41, and adjusts the phase of the single phase voltage, according to the voltage phase control signal, to generate a first phase voltage Va, a second phase voltage Vb, a third phase voltage Vc, and a fourth phase voltage Vd. The three AC light-emitting diode modules 33-35 are electrically coupled into a Y-shape. The AC light-emitting diode module 33 emits red light according to the difference between the first and fourth phase voltages Va, Vd. The AC light-emitting diode module 34 emits green light according to the difference between the second and fourth phase voltages Vb, Vd. The AC light-emitting diode module 35 emits blue light according to the difference between the third and fourth phase voltages Vc, Vd. Through voltage phase adjustment, color temperature of the AC light-emitting device 3 may be changed. However, since this configuration of the AC light-emitting device 3 uses many signals (that is, the first, second, third, and fourth phase voltages Va, Vb, Vc, Vd) to adjust the color temperature, many electrical elements are required.

### SUMMARY OF THE INVENTION

Therefore, an object of the present invention is to provide an AC light-emitting device which, by changing voltage amplitude of an AC electrical signal or adjusting waveform level of the AC electrical signal, can adjust the brightness and color temperature of the AC light-emitting device, and provide overheating protection for the AC light-emitting device.

By adjusting the voltage amplitude or waveform level of the AC electrical signal, the present invention only needs a drive signal to be able to adjust the brightness and color temperature of the AC light-emitting device. Aside from reducing the required number of electrical elements, overheating protection for the AC light-emitting device may be provided as well.

### BRIEF DESCRIPTION OF THE DRAWINGS

Other features and advantages of the present invention will become apparent in the following detailed description of the preferred embodiments with reference to the accompanying drawings, of which:

FIG. 1 is a circuit diagram showing another conventional AC light-emitting device;

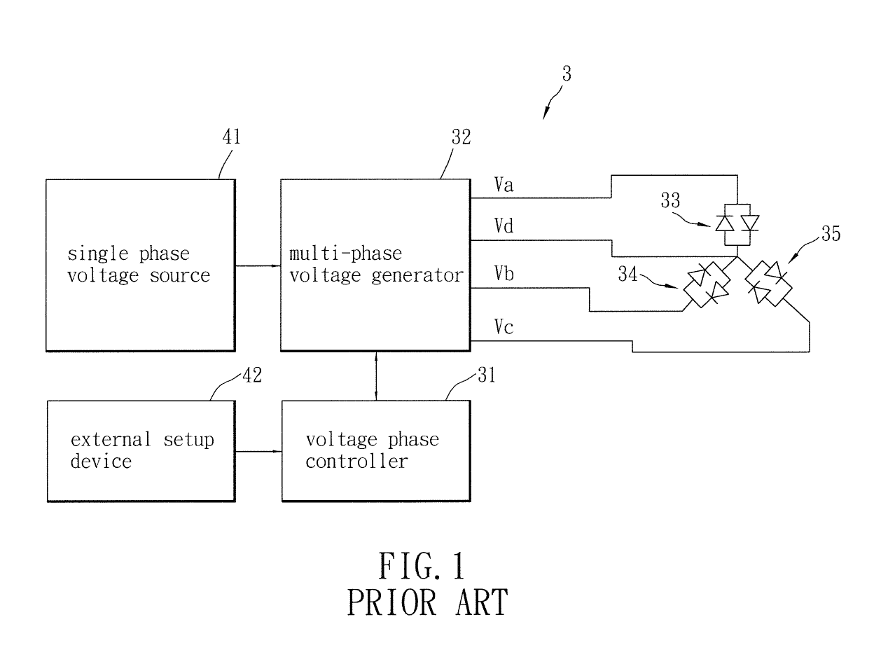

FIG. 2 is a waveform diagram showing a plurality of voltage phases generated in the AC light-emitting device shown in FIG. 1;

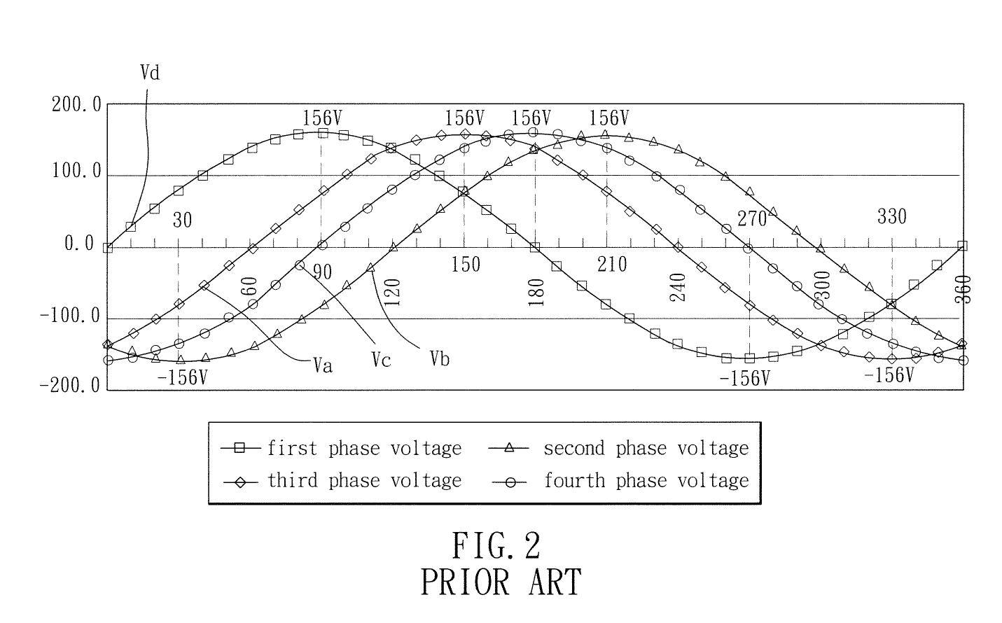

FIG. 3 is a circuit diagram showing the preferred embodiment of an AC light-emitting device of the present invention;

FIGS. 4(a), 4(b) and 4(c) show three waveform diagrams of waveform levels of a drive signal that is capable of being generated in the AC light-emitting device of the preferred embodiment;

FIGS. 5(a), 5(b) and 5(c) show three waveform diagrams of different waveforms of the drive signal that is capable of being generated in the AC light-emitting device of the preferred embodiment; and

FIG. 6 is a circuit diagram showing another preferred embodiment of the AC light-emitting device of the present invention.

### DETAILED DESCRIPTION OF THE PREFERRED EMBODIMENTS

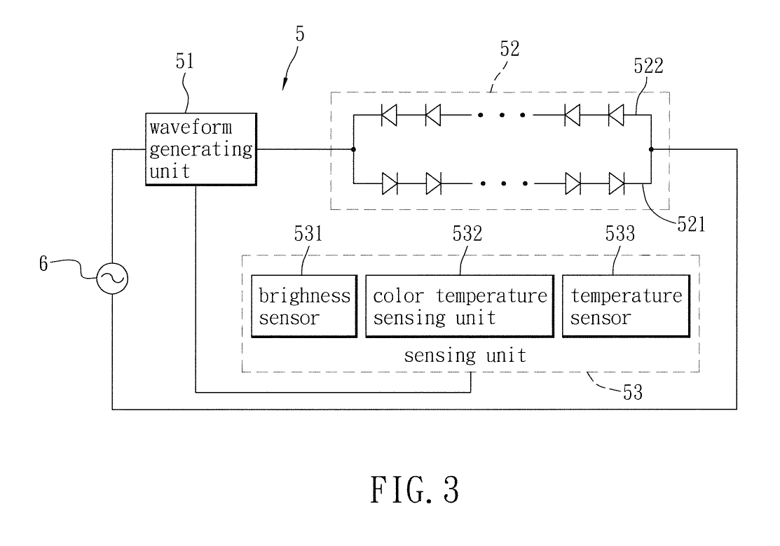

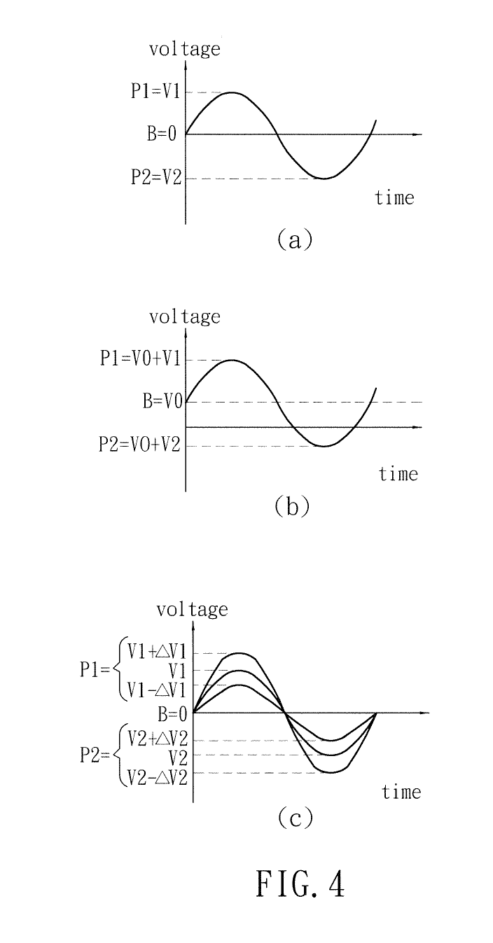

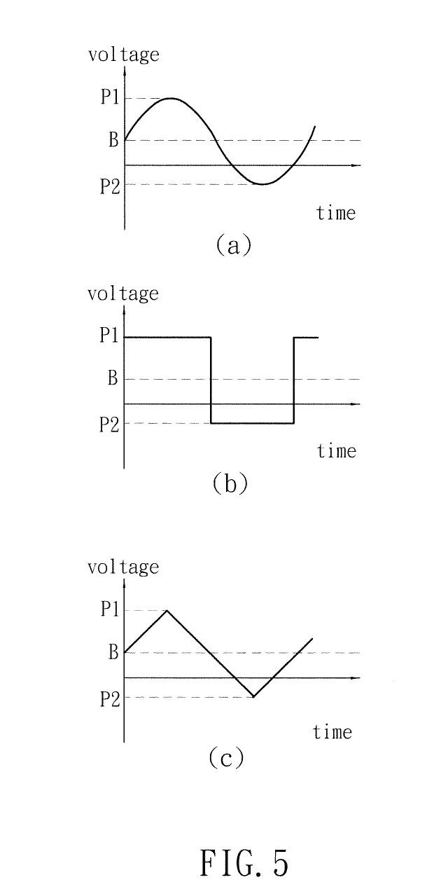

FIG. 3, FIG. 4 and FIG. 5 show the first preferred embodiment of the AC light-emitting device 5 of the present invention, which receives a sinusoidal AC electrical signal from an external AC power source (such as a commercial power supply). The AC light-emitting device 5 includes a waveform generating unit 51, an AC light-emitting unit 52 and a sensing unit 53.

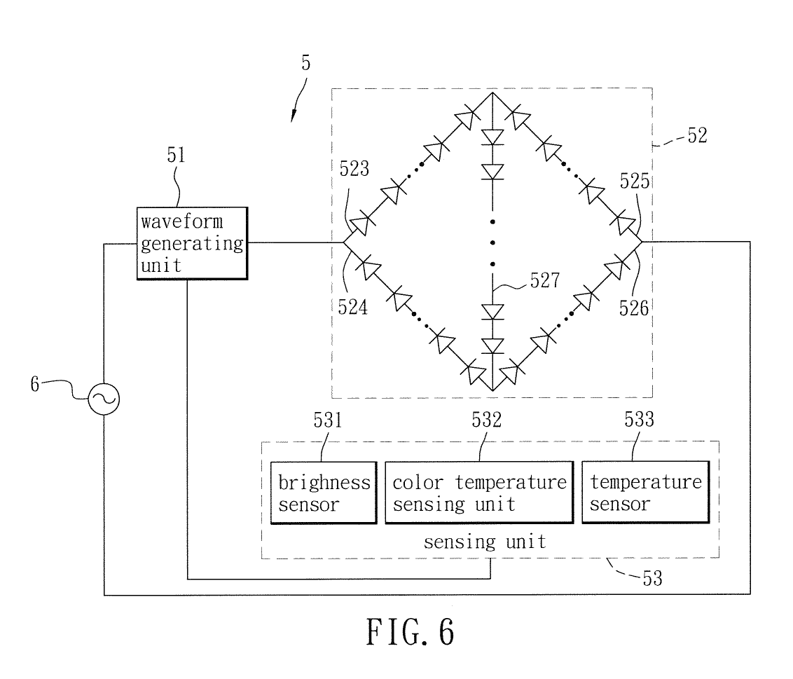

The waveform generating unit 51 is configured to receive the AC electrical signal from the AC power source 6 and to generate a drive signal by adjusting one of: voltage amplitude of the AC electrical signal during one of positive and negative half-cycles of the AC electrical signal; and waveform level B of the AC electrical signal. Herein, the waveform level is defined as a plurality of levels that have different voltage value, the waveform generating unit can adjust the waveform level without changing the shape of wave for the purpose of changing the peak value of the AC electrical signal. As shown in FIGS. 6(a) to 6(c), the waveform generating unit 51 can be configured to adjust the waveform level B of the AC electrical signal to change the positive half-cycle peak value P1 and the negative half-cycle peak value P2 of the AC electrical signal according to the adjusted waveform level B. The waveform generating unit 51 can be also configured to adjust the voltage amplitude of the AC electrical signal, for changing the positive half-cycle voltage peak value P1 during the positive half-cycle, or for changing the negative half-cycle voltage peak value P2 during the negative half-cycle.

As shown in FIG. 4(a), when the waveform generating unit 51 is not adjusting the waveform level B of the AC electrical signal (i.e., when B=0), the positive and negative half-cycle peak values P1, P2 are V1 and V2, respectively. FIG. 4(b) shows the positive and negative half-cycle peak values P1, P2 to be V0+V1 and V0+V2, respectively, when the waveform generating unit 51 adjusts the waveform level B of the AC electrical signal to V0. The waveform of the AC electrical signal is not influenced by adjustment of the waveform level. In other words, the waveform generating unit 51 only shifts the waveform vertically (upward or downward) and does not change the shape of the waveform.

As shown in FIG. 4(a), while taking the waveform level B to be zero as an example, when the waveform generating unit 51 has not adjusted the voltage amplitude of the AC electrical signal, the positive and negative half-cycle voltage peak values P1, P2 are V1 and V2, respectively. As shown in FIG. 4(c), when the waveform generating unit 51 adjusts the voltage amplitude of the AC electrical signal, the positive and negative half-cycle voltage peak values P1, P2 can be V1±ΔV1 and V2±ΔV2, respectively. ΔV1 and ΔV2 can be the same or different.

In an embodiment, the waveform generating unit 51 does not change the waveform of the AC electrical signal, and the drive signal is thus a sinusoidal wave (as shown in FIG. 5(a)). In another embodiment, the waveform generating unit 51 changes the waveform of the AC electrical signal, and the drive signal can be a square wave (shown in FIG. 5(b)), a triangular wave (shown in FIG. 5(c)) or other shapes.

In an embodiment, the waveform generating unit 51 does not adjust the frequency of the AC electrical signal, and the drive signal and the AC electrical signal thus have the same frequency (e.g., 60 Hz). In another embodiment, the waveform generating unit 51 adjusts the frequency of the AC electrical signal so that the frequency of the drive signal is greater than the frequency of the AC electrical signal, such as having the frequency of the drive signal greater than 60 Hz.

The AC light-emitting unit 52 includes a first light-emitting component 521 and a second light-emitting component 522 having opposite forward-bias current directions and emitting different wavelength lights. The first and second light-emitting components 521, 522 each include a plurality of light-emitting diodes. The first and second light-emitting components 521, 522 are electrically coupled to the waveform generating unit 51 to receive the drive signal, and emit light in response to the drive signal. When the voltage of the drive signal is positive (i.e., during the positive half-cycle of the drive signal), the first light-emitting component 521 conducts to emit light. When the voltage of the drive signal is negative (i.e, during the negative half-cycle of the drive signal), the second light-emitting component 522 conducts to emit light.

In an embodiment, one of the first and second light-emitting components 521, 522 is a high voltage light-emitting diode (HV LED) module that emits white light, and the other one of the first and second light-emitting components 521, 522 is a HV LED module that emits red light. In another embodiment, the light-emitting unit 52 is an AC light-emitting diode module, one of the first and second light-emitting components 521, 522 emits a first wavelength light, and the other one of the first and second light-emitting components 521, 522 emits a second wavelength light. For example, when light emitted by the first and second light-emitting components 521, 522 are respectively red light and white light, the amount of red light from the first light-emitting component 521 can be adjusted for the purpose of controlling the color temperature of the AC light-emitting unit between warm white light and cold white light.

The sensing unit 53 is used to generate at least one sensing signal according to operating state of the AC light-emitting unit 52 sensed thereby. In this embodiment, the sensing unit 53 includes a brightness sensor 531, a color temperature sensing unit 532, and a temperature sensor 533. The brightness sensor 531 senses brightness of the AC light-emitting unit 52 and generates a brightness response signal corresponding to the brightness of the AC light-emitting unit 52. The color temperature sensing unit 532 senses color temperature of the AC light-emitting unit 52 and generates a color temperature response signal corresponding to the color temperature of the AC light-emitting unit 52. The temperature sensor 533 senses temperature of the AC light-emitting unit 52 and generates a temperature response signal corresponding to the temperature of the AC light-emitting unit 52.

The waveform generating unit 51 is electrically coupled to the sensing unit 53 to receive the brightness response signal, the color temperature response signal and the temperature response signal. The waveform generating unit 51 adjusts voltage amplitude of the AC electrical signal according to the brightness response signal to change or maintain the brightness of the AC light-emitting unit 52. The waveform generating unit 51 adjusts the voltage amplitude or waveform level B of the AC electrical signal according to the color temperature response signal to change or maintain the color temperature of the AC light-emitting unit 52. When the temperature of the AC light-emitting unit 52 is detected to be higher than a preset value according to the temperature response signal, the waveform generating unit 52 adjusts the voltage amplitude of the AC electrical signal, such as reducing the voltage amplitudes of the positive and negative half-cycles, so as to avoid damage to the AC light-emitting unit 52 due to overheating.

As an example, when the brightness sensor 531 detects a brightness of the AC light-emitting unit 52 to be greater than a higher preset threshold value (such as detecting a value 110% of a preset brightness value), the waveform generating unit 51 will adjust the voltage amplitude of the AC electrical signal according to the brightness response signal, such as having the voltage peak values P1, P2 adjusted to 99%×V1 or 99%×V2, or both 99%×V1 and 99%×V2, respectively. The brightness sensor 531 continues to detect the brightness of the AC light-emitting unit 52 after adjustment, and feeds detected information to the waveform generating unit 51. If the brightness of the AC light-emitting unit 52 is still greater than the higher preset threshold value, the voltage amplitude of the AC electrical signal continues to be adjusted, such as having the voltage peak values P1, P2 adjusted to 98%×V1 or 98%×V2, or both adjusted to 98%×V1 and 98%×V2, respectively. The process is repeated until the brightness of the AC light-emitting unit 52 is maintained inside a preset brightness range (i.e., plus or minus 10% of the preset brightness value).

On the other hand, when the brightness sensor 531 detects a brightness of the AC light-emitting unit 52 to be lower than a lower preset threshold value (such as 90% of the preset brightness value), the waveform generating unit 51 adjusts the voltage amplitude of the AC electrical signal according to the brightness response signal, such as having the voltage peak values P1, P2 adjusted to 101%×V1 or 101%×V2, or both adjusted to 101%×V1 and 101%×V2, respectively. The brightness sensor 531 continues to detect the brightness of the AC light-emitting unit 52 after adjustment, and feeds detected information to the waveform generating unit 51. If the brightness of the AC light-emitting unit 52 is still lower than the lower preset threshold value, the voltage amplitude of the AC electrical signal continues to be adjusted, such as having the voltage peak values P1, P2 adjusted to 102%×V1 or 102%×V2, or both adjusted to 102%×V1 and 102%×V2, respectively. The process is repeated until the brightness of the AC light-emitting unit 52 is maintained inside the preset brightness range (i.e., plus or minus 10% of the preset brightness value). The preset brightness value can be a preset value, or generated through storage of an initial brightness value of the AC light-emitting unit 52 when first activated.

Based on the same principle, the operation of the temperature sensor 533 generally follows the feedback operation associated with the brightness sensor 531. More specifically, when the temperature sensor 533 detects a temperature greater than a preset temperature value of the AC light-emitting unit 52, the waveform generating unit 51 adjusts the voltage amplitude of the AC electrical signal according to the temperature response signal, such as having the voltage peak values P1, P2 adjusted to 99%×V1 or 99%×V2, or both adjusted to 99%×V1 and 99%×V2, respectively. The temperature sensor 533 continues to detect the temperature of the AC light-emitting unit 52 after adjustment, and feeds detected information to the waveform generating unit 51. If the temperature of the AC light-emitting unit 52 is still higher than the preset temperature value, the voltage amplitude of the AC electrical signal continues to be adjusted, such as having the voltage peak values P1, P2 adjusted to 98%×V1 or 98%×V2, or both adjusted to 98%×V1 and 98%×V2, respectively. The process continues until the temperature of the AC light-emitting unit 52 is below the preset temperature value. The temperature response signal from the temperature sensor 533 is the signal with first priority that the waveform generating unit 51 responds to first in order to protect the AC light-emitting unit 52 from overheating.

As an example, the first light-emitting component 521 of the AC light-emitting unit 52 emits white light and the second light-emitting component 522 of the AC light-emitting unit 52 emits red light. When the color temperature sensing unit 532 detects a color temperature of the AC light-emitting unit 52 to be greater than a preset color temperature value (such as detecting a color temperature value of 5900K when the preset color temperature value is 5500K), the waveform generating unit 51 adjusts the waveform level B of the AC electrical signal according to the color temperature response signal, such as lowering the waveform level B by 0.1V (i.e., adjusting to V0-0.1V). The color temperature sensing unit 532 continues to detect the color temperature of the AC light-emitting unit 52 after adjustment, and feeds detected information to the waveform generating unit 51. When the color temperature sensing unit 532 detects the color temperature of the AC light-emitting unit 52 to be still greater than the preset color temperature value (such as detecting the color temperature value of 5800K that is greater than the preset color temperature value of 5500K), the waveform level B of the AC electrical signal continues to be adjusted, for example, adjusted by 0.2V (i.e., adjusting to V0-0.2V), until the color temperature of the AC light-emitting unit 52 is maintained at the preset color temperature value (5500K).

On the other hand, when the color temperature sensing unit 532 detects a color temperature of the AC light-emitting unit 52 to be lower than the preset color temperature value (such as detecting a color temperature value of 5000K when the preset color temperature value is 5500K), the waveform generating unit 51 adjusts the waveform level B of the AC electrical signal according to the color temperature response signal, such as increasing the waveform level B by 0.1V (i.e., adjusting to V0+0.1V). The color temperature sensing unit 532 continues to detect the color temperature of the AC light-emitting unit 52 after adjustment, and feeds detected information to the waveform generating unit 51. When the color temperature sensing unit 532 detects the color temperature of the AC light-emitting unit 52 to be still lower than the preset color temperature value (such as detecting the color temperature value of 5100K that is lower than the preset color temperature value of 5500K), the waveform level B of the AC electrical signal continues to be adjusted, for example, adjusted by 0.2V (i.e., adjusting to V0+0.2V), until the color temperature of the AC light-emitting unit 52 is maintained at the preset color temperature value (5500K).

As an example, the first light-emitting component 521 of the AC light-emitting unit 52 emits white light and the second light-emitting component 522 of the AC light-emitting unit 52 emits red light. When the color temperature sensing unit 532 detects a color temperature of the AC light-emitting unit 52 to be greater than the preset color temperature value (such as detecting a color temperature value of 5900K when the preset color temperature value is 5500K), the waveform generating unit 51 adjusts the voltage amplitude of the AC electrical signal according to the color temperature response signal, such as having the voltage peak values P1, P2 adjusted to 99%×V1 or 101%×V2 (i.e., the voltage peak value P1 of the positive half-cycle is smaller while absolute value of the voltage peak value P2 of the negative half-cycle is greater), or both adjusted to 99%×V1 and 101%×V2, respectively. The color temperature sensing unit 532 continues to detect the color temperature of the AC light-emitting unit 52 after adjustment, and feeds detected information to the waveform generating unit 51. If the color temperature of the AC light-emitting unit 52 is detected by the color temperature sensing unit 532 to be still higher than the preset color temperature value (such as detecting the color temperature value of 5800K that is still greater than the preset color temperature value of 5500K), the voltage amplitude of the AC electrical signal continues to be adjusted, such as having the voltage peak values P1, P2 adjusted to 98%×V1 or 102%×V2, or both adjusted to 98%×V1 and 102%×V2, respectively. The process continues until the color temperature of the AC light-emitting unit 52 is maintained at the preset color temperature value (5500K).

On the other hand, when the color temperature sensing unit 532 detects a color temperature of the AC light-emitting unit 52 to be lower than the preset color temperature value (such as detecting a color temperature value of 5000K when the preset color temperature value is 5500K), the waveform generating unit 51 adjusts the voltage amplitude of the AC electrical signal according to the color temperature response signal, such as having the voltage peak values P1, P2 adjusted to 101%×V1 or 99%×V2, or both adjusted to 101%×V1 and 99%×V2, respectively. The color temperature sensing unit 532 continues to detect the color temperature of the AC light-emitting unit 52 after adjustment, and feeds detected information to the waveform generating unit 51. If the color temperature sensing unit 532 detects the color temperature of the AC light-emitting unit 52 to be still lower than the preset color temperature value (such as detecting the color temperature value of 5200K that is still lower than the preset color temperature value of 5500K), the voltage amplitude of the AC electrical signal continues to be adjusted, such as having the voltage peak values P1, P2 adjusted to 102%×V1 or 98%×V2, or both adjusted to 102%×V1 and 98%×V2, respectively. The process continues until the color temperature of the AC light-emitting unit 52 is maintained at the preset color temperature value (5500K).

In another embodiment, the brightness sensor 531 can be configured to detect the brightness of the environment to generate a brightness response signal corresponding to the brightness of the environment. The brightness of the AC light-emitting unit 52 can be dynamically controlled by the waveform generating unit 51 according to the brightness response signal to conserve electricity.

The waveform gene rating unit 51 can be disposed inside or outside the package of the AC light-emitting unit 52.

In another embodiment, as shown in FIG. 6, the AC light-emitting unit 52 can include a first light-emitting component 523, a second light-emitting component 524, a third light-emitting component 525, a fourth light-emitting component 526 and a fifth light-emitting component 527 that are electrically coupled into a bridge structure. Each light-emitting component 523-527 includes a plurality of light-emitting diodes. The first and fourth light-emitting components 523, 526 emit a first wavelength light whereas the second, third and fifth light-emitting components 524, 525, 527 emit a second wavelength light that is different from the first wavelength light. All the light-emitting components 523-527 emit light according to the drive signal. When the voltage of the drive signal is positive, the first, fifth and fourth light-emitting components 523, 527, 526 conduct to emit light. When the voltage of the drive signal is negative, the third, fifth and second light-emitting components 525, 527, 524 conduct to emit light. For example, when the first and fourth light-emitting components 523, 526 emit red light and the second, third and fifth light-emitting components 524, 525, 527 emit white light, the first, fifth and fourth light-emitting components 523, 527, 526 are conducted to emit red light (with white light) during the positive half-cycle; the third, fifth and second light-emitting components 525, 527, 524 are conducted to emit white light during the negative half-cycle. By which, the color temperature with warm white color can be reached by increasing the voltage amplitude of the AC electrical signal during a positive half-cycle and maintaining the voltage amplitude of the AC electrical signal during a negative half-cycle. In the same way, the color temperature with cold white color can be reached by reducing the voltage amplitude of the AC electrical signal during a positive half-cycle and maintaining the voltage amplitude of the AC electrical signal during a negative half-cycle. Therefore, the color temperature can be changed between warm white and cold white by changing the voltage amplitude of the AC electrical signal during one of the positive and negative half-cycle. Accordingly, the color temperature also can be changed by adjusting the waveform level of the AC electrical signal.

From the above description, the embodiments of this invention have the following advantages: 1. By adjusting the voltage amplitude or waveform level B of the AC electrical signal, only a drive signal is needed to adjust the brightness and color temperature of the AC light-emitting device 5, and also to effectively reduce the required number of electrical components. 2. The embodiments can use a commercial AC power supply to provide the AC electrical signal. 3. The control of brightness and color temperature and the provision of overheating protection are achievable through inclusion of the brightness sensor 531, the color temperature sensing unit 532 and the temperature sensor 533.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An alternating current (AC) light-emitting device comprising:
a waveform generating unit configured to receive an AC electrical signal and to generate a drive signal by adjusting one of: voltage amplitude of the AC electrical signal during one of positive and negative half-cycles of the AC electrical signal, and waveform level of the AC electrical signal; and
an AC light-emitting unit including a first light-emitting component and a second light-emitting component, said second light-emitting component emitting a different wavelength light compared to that of said first light-emitting component, wherein said first and second light-emitting components are electrically coupled to said waveform generating unit to receive the drive signal, and emit light according to the drive signal.

2. The AC light-emitting device as claimed in claim 1, wherein the first light-emitting component is conducted to emit light during positive half-cycle of the AC electrical signal, the second light-emitting component is conducted to emit light during negative half-cycle of the AC electrical signal.

3. The AC light-emitting device as claimed in claim 1, wherein said AC light-emitting unit further includes a third light-emitting component, a fourth light-emitting component and a fifth light-emitting component,
said first, second, third, fourth and fifth light-emitting components being electrically connected in a bridge structure,
said first and fourth light-emitting components emitting first wavelength light,
said second, third and fifth light-emitting components emitting second wavelength light.

4. The AC light-emitting device as claimed in claim 3, wherein said first, fifth and fourth light-emitting components are conducted to emit light during positive half-cycle of the AC electrical signal; and said third, fifth and second light-emitting components are conducted to emit light during negative half-cycle of the AC electrical signal.

5. The AC light-emitting device as claimed in claim 1, wherein said AC light-emitting unit is an AC light-emitting diode module including said first and second light-emitting components that are connected in parallel and that have opposite forward-bias current directions, one of said first and second light-emitting components emitting white light, the other of said first and second light-emitting components emitting red light so as to adjust color temperature of said AC light-emitting unit between warm white and cold white.

6. The AC light-emitting device as claimed in claim 1 further comprising:
a sensing unit to generate at least one sensing signal according to operating state of said AC light-emitting unit sensed thereby;
wherein said waveform generating unit is further electrically coupled to said sensing unit to receive the sensing signal, and adjusts one of the voltage amplitude and the waveform level of the AC electrical signal according to the sensing signal.

7. The AC light-emitting device as claimed in claim 6, wherein said sensing unit is selected from the group consisting of a brightness sensor, a color temperature sensing unit, and a temperature sensor.

8. The AC light-emitting device as claimed in claim 7, wherein
said temperature sensor senses temperature of said AC light-emitting unit and generates a temperature response signal corresponding to the temperature of said AC light-emitting unit;
said waveform generating unit adjusts the voltage amplitude of the AC electrical signal according to the temperature response signal to protect said AC light-emitting unit from overheating.

9. The AC light-emitting device as claimed in claim 8, wherein the waveform generating unit process said temperature response signal at first for avoiding overheating to the AC light-emitting unit.

10. The AC light-emitting device as claimed in claim 8, wherein when the temperature of said AC light-emitting unit is higher than a present value, said waveform generating unit reduces the voltage amplitude of AC electrical signal.

11. The AC light-emitting device as claimed in claim 7, wherein
said brightness sensor senses brightness of said AC light-emitting unit and generates a brightness response signal corresponding to the brightness of said AC light-emitting unit;
said waveform generating unit adjusts the voltage amplitude of the AC electrical signal according to the brightness response signal to change the brightness of said AC light-emitting unit.

12. The AC light-emitting device as claimed in claim 11, wherein said brightness sensor is further configured to detect brightness of environment to generate an environment brightness response signal;
the brightness of the AC light-emitting unit is dynamically controlled by the waveform generating unit according to the environment brightness response signal.

13. The AC light-emitting device as claimed in claim 7, wherein
said color temperature sensing unit senses color temperature of said AC light-emitting unit and generates a color temperature response signal corresponding to the color temperature of said AC light-emitting unit;
said waveform generating unit adjusts one of the voltage amplitude and the waveform level of the AC electrical signal according to the color temperature response signal to change the color temperature of said AC light-emitting unit.

14. The AC light-emitting device as claimed in claim 13, wherein when the color temperature is not in range of a preset value, the waveform generating unit adjusts one of the voltage amplitude and the waveform level of the AC electrical signal to change the color temperature of AC light-emitting unit

15. The AC light-emitting device as claimed in claim 1, wherein the waveform of said drive signal is selected from the group consisting of a sinusoidal wave, a square wave and a triangular wave.

16. The AC light-emitting device as claimed in claim 1, wherein said drive signal and said AC electrical signal have substantively similar frequency.
